(19) United States
(12) Patent Application Publication
(10) Pub. No.: US 2023/0051897 A1
(43) Pub. Date: Feb. 16, 2023

(54) SMART BALANCE TREE LOOKUP

(71) Applicant: ARRIS Enterprises LLC, Suwanee, GA (US)

(72) Inventors: Anand Kumar GOENKA, Bengaluru (IN); Diwakar CHAKRABORTY, Bengaluru (IN)

(73) Assignee: ARRIS Enterprises LLC, Suwanee, GA (US)

(21) Appl. No.: 17/861,908

(22) Filed: Jul. 11, 2022

Related U.S. Application Data
(60) Provisional application No. 63/232,067, filed on Aug. 11, 2021.

(51) Int. Cl. G06F 16/22

(52) U.S. Cl. CPC G06F 16/2246; G06F 16/2272

(57) ABSTRACT

The present disclosure describes techniques for performing a smart tree lookup operation in a balanced tree. The techniques according to the present disclosure comprise identifying at least one data entry to be searched within the balanced tree, extracting a plurality of keys of the balanced tree, determining whether all or a subset of keys of the plurality of keys are required for searching the at least one data entry within the balanced tree, in response to the determination that the subset of keys of the plurality of keys are required for searching the at least one data entry, generating a first compare function for each of the at least one data entry using the subset of keys, and traversing a first path for the at least one data entry based on the first compare function. Accordingly, the techniques of the present disclosure enable efficient balanced tree lookup operation.

### TECHNICAL FIELD

The present disclosure in general relates to data structures. More particularly, but not exclusively, to techniques of performing a balanced tree lookup operation.

### BACKGROUND

Data structures are often believed to be the core or the foundation of computer science. With developments in the computer science, there is a requirement of more data processing and storage. The gigantic amount of data results in an increase in processing time of the systems. This is where data structures reduce the processing time by effective utilization of the stored data.

A binary tree is a special data structure used for data storage. The tree is a data type that simulates a hierarchical tree structure, with a root value and subtrees of children with a parent node, represented as a set of linked nodes. Data structures also aid in tasks such as data searches, which play an important role in enhancing the performance of a program given that the main function of the program is to store and retrieve the user's data as fast as possible for various applications.

In a binary search tree (BST), each node stores information including a unique key value, and perhaps some associated data. A self-balancing binary search tree is a BST that attempts to keep its height, or the number of levels of nodes beneath the root, as small as possible at all times, automatically.

Searching for a value in the BST is quite similar to an add operation. Search or lookup techniques traverse the tree “in-depth.” Specifically, after choosing an appropriate path, a property of a binary search tree is followed to compare the unique key value of the each visited node to desired one. Whenever an element is to be searched, the search is started from the root node, then if the data is less than the key value, the element is searched in the left subtree. Otherwise, the element is searched in the right subtree. The same technique is followed for each node.

The lookup operation in a balanced tree can be performed using all or subset of keys. Presently, in such scenario the lookup operations are performed by organizing the same data in multiple trees with different set of keys. However, organization of the same data in multiple trees with different set of keys requires management of multiple trees for same data set, thereby increasing the memory requirement.

Thus, there exists a need in the art to provide a technique which overcomes the above-mentioned problems to perform the balanced tree lookup operation using a single balanced tree, and use only the subset of keys for traversing a particular portion of the tree.

The information disclosed in this background section is only for enhancement of understanding of the general background as identified in the disclosure and should not be taken as an acknowledgement or any form of suggestion that this information forms the prior art already known to a person skilled in the art.

### SUMMARY

An object of the present disclosure is to leverage the hierarchical organization of balanced tree with multiple keys.

Another object of the present disclosure is to reduce the search complexity while performing the balanced tree lookup.

Yet another object of the present disclosure is to efficiently perform balanced tree lookup operation with multiple keys and to eliminate the requirement of managing multiple trees for same data set.

The above stated objects as well as other objects, features, and advantages of the present disclosure will become clear to those skilled in the art upon review of the following description, the attached drawings, and the appended claims.

In one non-limiting embodiment of the present disclosure, a method comprises identifying at least one data entry to be searched within the balanced tree, extracting a plurality of keys of the balanced tree, determining whether all or a subset of keys of the plurality of keys are required for searching the at least one data entry within the balanced tree, in response to the determination that the subset of keys of the plurality of keys are required for searching the at least one data entry, generating a first compare function for each of the at least one data entry using the subset of keys, and traversing a first path for the at least one data entry based on the first compare function.

In another non-limiting embodiment of the present disclosure, the first compare function comprises the subset of keys in a hierarchical order.

In yet another non-limiting embodiment of the present disclosure, traversing the at least one data entry comprises traversing at least a portion of the balanced tree and detecting one or more duplicate data entry with respect to the at least one data entry.

In yet another non-limiting embodiment of the present disclosure, the method further comprises in response to the determination that all keys of the plurality of keys are required for searching the at least one data entry, generating a second compare function for each of the at least one data entry to be searched using all of the keys, and traversing a second path for the at least one data entry based on the second compare function.

In yet another non-limiting embodiment of the present disclosure, the method further comprises performing an action on the at least one data entry based on at least one of the first or the second traversed path, wherein the action comprises at least one of: retrieving the at least one data entry, or adding a data entry, deleting the at least one data entry, or modifying the at least one data entry.

In yet another non-limiting embodiment of the present disclosure, the first path and the second path are traversed by passing the first compare function and the second compare function to a balanced tree search routine or an Application Programming Interface (API).

In yet another non-limiting embodiment of the present disclosure, an apparatus comprises a memory, a processing unit in communication with the memory and configured to identify at least one data entry to be searched within the balanced tree, extract a plurality of keys of the balanced tree, determine whether all or a subset of keys of the plurality of keys are required for searching the at least one data entry within the balanced tree, in response to the determination that the subset of keys of the plurality of keys are required for searching the at least one data entry, generate a first compare function for each of the at least one data entry using the subset of keys, and traverse a first path for the at least one data entry based on the first compare function.

In yet another non-limiting embodiment of the present disclosure, to traverse the at least one data entry the at least one processor is configured to traverse at least a portion of the balanced tree and detect one or more duplicate data entry with respect to the at least one data entry.

In yet another non-limiting embodiment of the present disclosure, the processing unit is further configured to perform an action on the at least one data entry based on at least one of the first or the second traversed path, wherein the action comprises at least one of: retrieving the at least one data entry, or adding a data entry, deleting the at least one data entry, or modifying the at least one data entry.

In yet another non-limiting embodiment of the present disclosure, a non-transitory computer readable medium having computer-readable instructions that when executed by a processor causes the processor to perform operations of identifying at least one data entry to be searched within the balanced tree, extracting a plurality of keys of the balanced tree, determining whether all or a subset of keys of the plurality of keys are required for searching the at least one data entry within the balanced tree, in response to the determination that the subset of keys of the plurality of keys are required for searching the at least one data entry, generating a first compare function for each of the at least one data entry using the subset of keys, and traversing a first path for the at least one data entry based on the first compare function.

In a furthermore non-limiting embodiment of the present disclosure, the computer-readable medium further comprises computer-readable instructions that when executed by the processor causes the processor to perform operations of traversing at least a portion of the balanced tree and detecting one or more duplicate data entry with respect to the at least one data entry.

In a furthermore non-limiting embodiment of the present disclosure, the non-transitory computer-readable medium further comprises computer-readable instructions that when executed by the processor causes the processor to perform operations of in response to the determination that all keys of the plurality of keys are required for searching the at least one data entry generating a second compare function for each of the at least one data entry to be searched using all of the keys and traversing a second path for the at least one data entry based on the second compare function.

In a furthermore non-limiting embodiment of the present disclosure, the non-transitory computer-readable medium further comprises computer-readable instructions that when executed by the processor causes the processor to perform operations of: performing an action on the at least one data entry based on at least one of the first or the second traversed path, wherein the action comprises at least one of: retrieving the at least one data entry, or adding a data entry, deleting the at least one data entry, or modifying the at least one data entry.

Particular advantages provided by at least one of the disclosed embodiments include effective utilization of the standby mode of the set top box (STB) by leveraging the capabilities supported on the STB. The disclosed embodiments transform the STB into an assistance device without the need of any additional hardware from third party or external vendor. In one particular embodiment, the disclosed embodiments transform the STB operating in standby mode into a smart music player while significantly extending user experience when a user is not interested in watching television.

The foregoing summary is illustrative only and is not intended to be in any way limiting. In addition to the illustrative embodiments, and features described above, further embodiments, and features will become apparent by reference to the drawings and the following detailed description.

### BRIEF DESCRIPTION OF THE ACCOMPANYING DRAWINGS

The accompanying drawings, which are incorporated in and constitute a part of this disclosure, illustrate exemplary embodiments and, together with the description, serve to explain the disclosed principles. Some embodiments of system and/or methods in accordance with embodiments of the present subject matter are now described, by way of example only, and with reference to the accompanying Figures, in which:

FIG. 1(a) shows an exemplary environment illustrating a Remote Physical (RPHY) environment 100 comprising Remote Physical Device (RPD) connected to a Converged Cable Access Platform CCAP) core, in accordance with some embodiments of the present disclosure;

FIG. 1(b) illustrates a Balance Tree with 3 keys/levels, in accordance with some embodiments of the present disclosure;

FIG. 2(a) illustrates a normal Balance Tree with 3 keys for performing lookup using 3 keys, in accordance with some embodiments of the present disclosure;

FIG. 2(b) illustrates a normal Balance Tree with 2 keys for performing lookup using 2 keys, in accordance with some embodiments of the present disclosure;

FIG. 3 depicts a flowchart 300 illustrating an example method of performing a smart tree lookup operation in a balanced tree, in accordance with some embodiments of the present disclosure;

FIG. 4(a) shows a block diagram of a system 400(a) for performing a smart tree lookup operation in a balanced tree, in accordance with some embodiments of the present disclosure;

FIG. 4(b) shows a block diagram of a system 400(b) for performing a smart tree lookup operation in a balanced tree, in accordance with some embodiments of the present disclosure;

FIG. 5(a) illustrates a smart Balance Tree with 3 keys for performing lookup operation using 3 keys, in accordance with some embodiments of the present disclosure;

FIG. 5(b) illustrates a smart Balance Tree with 3 keys for performing lookup operation using 2 keys, in accordance with some embodiments of the present disclosure;

FIG. 6(a) illustrates a smart Balance Tree with 4 keys/levels, in accordance with some embodiments of the present disclosure;

FIG. 6(b) illustrates a smart Balance Tree with 4 keys for performing lookup operation using 4 keys, in accordance with some embodiments of the present disclosure; and

FIG. 6(c) illustrates a smart Balance Tree with 4 keys for performing lookup operation using 3 keys, in accordance with some embodiments of the present disclosure.

It should be appreciated by those skilled in the art that any block diagrams herein represent conceptual views of the illustrative systems embodying the principles of the present subject matter. Similarly, it will be appreciated that any flowcharts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiments thereof have been shown by way of example in the drawings and will be described in detail below. It should be understood, however, that these embodiments are not intended to limit the disclosure to the particular form disclosed, but on the contrary, the disclosure is to cover all modifications, equivalents, and alternatives falling within the spirit and the scope of the disclosure.

The terms “comprise(s)”, “comprising”, “include(s)”, or any other variations thereof, are intended to cover a non-exclusive inclusion, such that a setup, device, apparatus, system, or method that comprises a list of components or steps does not include only those components or steps but may include other components or steps not expressly listed or inherent to such setup or device or apparatus or system or method. In other words, one or more elements in a device or system or apparatus proceeded by “comprises . . . a” does not, without more constraints, preclude the existence of other elements or additional elements in the system.

The terms like “at least one” and “one or more” may be used interchangeably or in combination throughout the description.

In the following detailed description of the embodiments of the disclosure, reference is made to the accompanying drawings that form a part hereof, and in which are shown by way of illustration of specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense. In the following description, well known functions or constructions are not described in detail since they would obscure the description with unnecessary detail.

Disclosed herein is a technique for performing a smart tree look operation in a balanced tree. The technique according to the present disclosure comprise identifying at least one data entry to be searched within the balanced tree, extracting a plurality of keys of the balanced tree, determining whether all or a subset of keys of the plurality of keys are required for searching the at least one data entry within the balanced tree, in response to the determination that the subset of keys of the plurality of keys are required for searching the at least one data entry, generating a first compare function for each of the at least one data entry using the subset of keys, and traversing a first path for the at least one data entry based on the first compare function. Accordingly, the techniques according to the present disclosure enable efficient balanced tree lookup operation with requiring multiple trees to maintain the same data set.

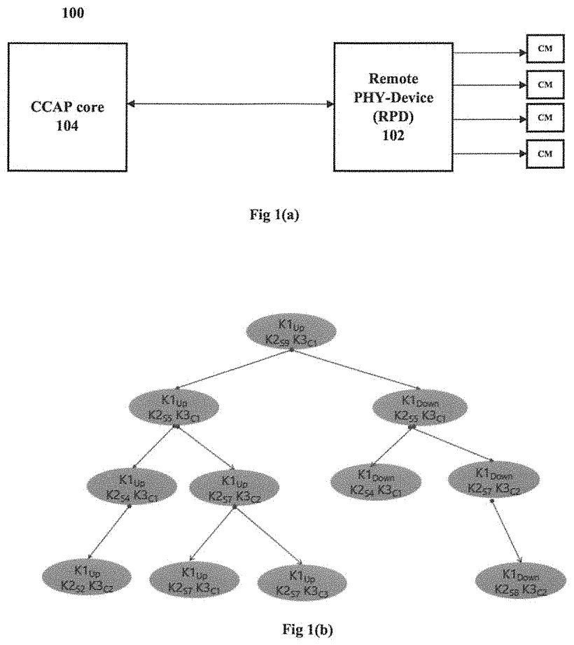

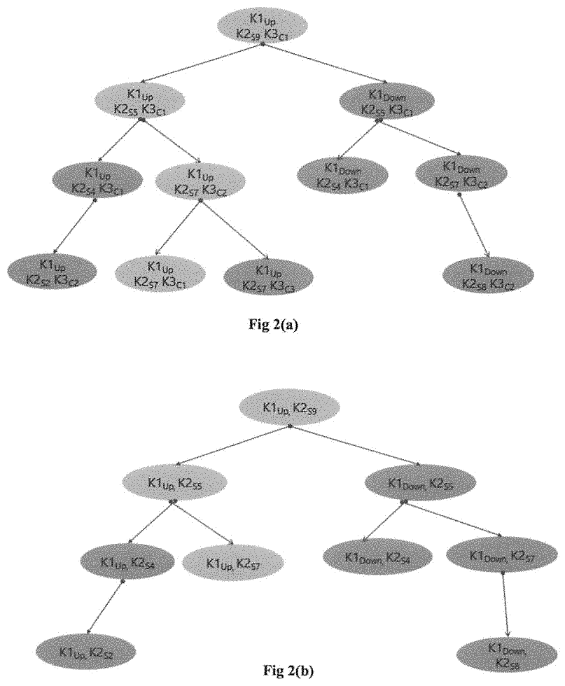

FIG. 1(a) shows an exemplary environment illustrating a Remote Physical (RPHY) environment 100 comprising Remote Physical Device (RPD) connected to a Converged Cable Access Platform CCAP) core, in accordance with some embodiments of the present disclosure.

The RPHY environment 100 may broadly include a Remote Physical device (RPD) 102 connected to a Converged Cable Access Platform (CCAP) core 104 via one or more wired or wireless networks, such as ethernet. The RPD 102 and the CCAP core 104 communicate data between each other in an upstream direction from the RPD 102 to the CCAP core 104 and in a downstream direction from the CCAP core 104 to the RPD 102. Those skilled in the art will appreciate that, although not expressly shown, the CCAP core (104) may include a Cable Modem Termination System (CMTS) Core for Data Over Cable Service Interface Specifications (DOCSIS) and an Edge Quadrature Amplitude Modulation (EQAM) Core for Video.

Those skilled in the art will also appreciate that the RPD 102 may include, among other essential components, a DOC SIS PHY layer, a downstream Quadrature Amplitude Modulation (QAM) modulator (not shown), upstream QAM, demodulators (not shown), together with pseudowire logic (not shown) that is configured to connect the CCAP Core (104) to the RPD 102. It may be noted that the RPD 102 and the CCAP core 104 include other essential components/elements required to carry out the desired functionalities and the same have not been explained here for the sake of brevity.

In an exemplary embodiment, FIG. 1A shows a single RPD 102 connected to a single CCAP core 104. However, various other embodiments may be possible where more than one RPD 102 may be connected to a single CCAP core 104 or one RPD 102 may be connected to multiple CCAP cores 104.

The RPHY environment 100 may comprise Precision Time Protocol (PTP) server (not shown) connected to both the RPD 102 and the CCAP core 104 to synchronize one or more slave clocks (not shown) present inside each of the RPD 102 and the CCAP core 104 to a master clock (not shown) of the PTP server, and also synchronize the slave clocks of the RPD 102 and the CCAP core 104 to each other. Further, FIG. 1A shows the RPD 102 connected to a plurality of Cable Modems (CMs), e.g., using wired and/or wireless technology.

FIG. 1(b) illustrates a Balance Tree with 3 keys/levels, in accordance with some embodiments of the present disclosure.

In an exemplary embodiment of the present disclosure, an RPD may maintain a database of Layer 2 Tunneling Protocol (L2TP) sessions. The L2TP sessions may be in respective ones of the upstream and downstream directions, and may be established from one or more CCAP cores. The session tree may then comprise at least the following keys but not limited to direction (upstream or downstream) (K1), session ID (K2), and CCAP core address (K3).

As shown in FIG. 1(b), the balanced tree comprises a root node (K1ᵤₚ K2_{S9} K3_{C1}). The upstream data (K1ᵤₚ) is stored in the left portion of the balanced tree and the downstream data (K1_{Down}) may be stored in the right portion of the balanced tree. One or more actions may be performed on the balanced tree such as retrieving the at least one data entry, or adding a data entry, deleting the at least one data entry, or modifying the at least one data entry, or searching at least one data entry.

Previously, the RPD 102 was used to maintain a plurality of separate trees of L2TP sessions based on all or subset of keys required for performing plurality of lookup or search operations, as exemplified in FIGS. 2(a) and 2(b). For example, consider the following two lookup cases:

Case-A—To find whether the tree already has a session entry with given direction, session id and CCAP core address. This type of lookup is typically used for finding a duplicate session add request from the same core.
Case-B—To find whether the tree already has a session entry with given direction and session id (irrespective of CCAP core address). This type of lookup is typically used for finding a duplicate session entries among all the cores.

In the above example, the RPD maintains a first tree/database (Tree-1) comprising the 3 keys i.e., direction (upstream or downstream) (K1), session ID (K2), and CCAP Core Address (K3) as shown in FIG. 2(a) and a second tree/database (Tree-2) comprising the direction (upstream or downstream) (K1) and session ID (K2) as shown in FIG. 2(b).

The above mentioned lookups may be performed using the two separate trees. The first balanced tree comprises three keys (K1, K2, K3) for performing the lookup operation for data entry K1ᵤₚ K2_{S7} K3_{C1}. The second balanced tree comprises two keys (K1, K2) for performing the lookup operation for data entry K1ᵤₚ K2_{S7}.

The two separate trees may comprise their own search function based on their respective keys for performing the lookup operation. The highlighted blocks in FIG. 2(a) indicate path traversed for searching the data entry K1ᵤₚ K2_{S7} K3_{C1} in the first tree and the highlighted blocks in FIG. 2(b) indicate path traversed for searching the data entry K1ᵤₚ K2s7 in the second tree.

However, the organization of the same data in multiple trees as shown in FIGS. 2(a) and 2(b) with different set of keys requires management of multiple tress, thereby increasing the memory requirement. The present application overcomes the above-mentioned drawback by performing smart tree lookup within the same tree using different compare functions generated based on the different subset of keys.

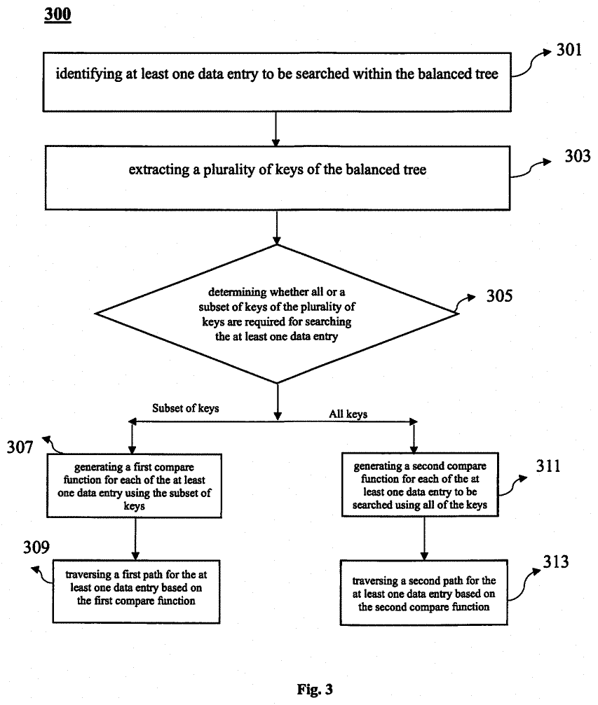

FIG. 3 depicts a flowchart 300 illustrating an example method of performing a smart tree lookup operation in a balanced tree, in accordance with some embodiments of the present disclosure.

At block 301, the method 300 discloses identifying at least one data entry to be searched within the balanced tree. The data entry may be stored in the database of the RPD. The identification of data entry may be required for checking duplicate or redundant data entry of the RPD.

At block 303, the method 300 discloses extracting a plurality of keys of the balanced tree. In this step, all the keys present in the balanced tree are extracted. In an exemplary embodiment of the present disclosure, the plurality of keys may comprise K1, K2, and K3, where K1 is the Most Significant Bit (MSB) portion of the key and K3 is the Least Significant Bit (LSB) part of the keys. All the keys K1, K2, and K3 shall be required for adding or deleting a data entry from the balanced tree.

At block 305, the method 300 discloses determining whether all or a subset of keys of the plurality of keys are required for searching the at least one data entry within the balanced tree. The tree search or lookup operation may be performed either with all keys or subset of keys. For example, tree lookup may be performed using all three keys K1, K2 and K3 or only with K1 and K2. The determination of whether all or a subset of keys are required is based on the at least one identified data entry to be searched.

In an exemplary embodiment, if the at least one identified data entry comprises keys K1 and K2, then only a subset of keys are required for performing the search operation. If the at least one identified data entry comprises keys K1, K2, and K3 then all the keys are required for performing the search operation.

At block 307, in response to the determination that the subset of keys of the plurality of keys are required for searching the at least one data entry, a first compare function is generated for each of the at least one data entry using the subset of keys. The first compare function comprises the subset of keys in a hierarchical order. In an exemplary embodiment, the first compare function generated using subset of keys may be indicated a function ((K1) and (K2)).

At block 309, a first path for the at least one data entry is traversed based on the first compare function. The traversing the first path for the at least one data entry comprises traversing at least a portion of the balanced tree and detecting one or more duplicate data entry with respect to the at least one data entry.

At block 311, in response to the determination that all keys of the plurality of keys are required for searching the at least one data entry, a second compare function is generated for each of the at least one data entry to be searched using all of the keys. In an exemplary embodiment, the second compare function generated using all the keys may be indicated a function ((K1), (K2), and (K3)).

At block 313, a second path for the at least one data entry is traversed based on the second compare function. The traversing the second path for the at least one data entry comprises traversing at least a portion of the balanced tree and detecting one or more duplicate data entry with respect to the at least one data entry.

In an embodiment of the present disclosure, the method 300 performs an action on the at least one data entry based on at least one of the first or the second traversed path, wherein the action comprises at least one of: retrieving the at least one data entry, or adding a data entry, deleting the at least one data entry, or modifying the at least one data entry.

In an embodiment of the present disclosure, the first path and the second path are traversed by passing the first compare function and the second compare function to a balanced tree search routine or an Application Programming Interface (API).

Thus, the method 300 eliminates the requirement of organizing the same set of elements in separate trees. The method 300 also facilitates different types of lookups on same tree instance by simply having different search functions (one for each lookup) with different set of keys, as long as keys are in hierarchical order. Further, the method 300 further facilitates reduction in search complexity of lookups with lesser number of keys.

In another non-limiting embodiment of the present disclosure, the steps of method 300 may be performed in an order different from the order described above.

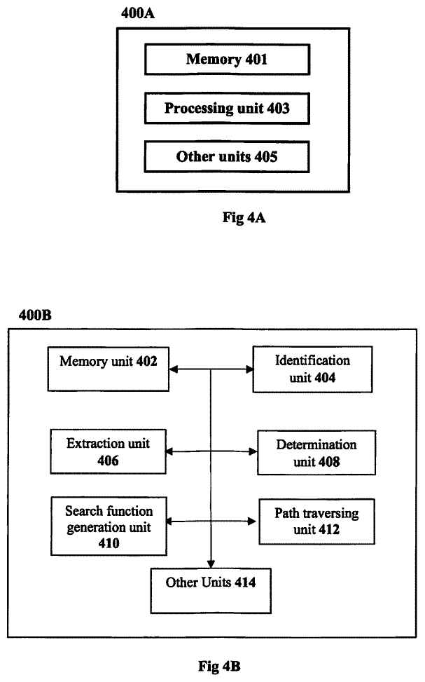

FIG. 4(a) shows a block diagram of a system 400(a) for performing a smart tree lookup operation in a balanced tree, in accordance with some embodiments of the present disclosure.

In an embodiment of the present disclosure, the system 400(a) comprises memory 401, a processing unit 403, and other units 405 communicatively coupled with each other. The system 400 (a) may be an RPD or any other device. The memory 401 may be configured to store the L2TP session of the RPD. The processing unit 403 may be configured to identify at least one data entry to be searched within the balanced tree. The data entry may be stored in the database of the RPD. The identification of data entry may be required for checking duplicate or redundant data entry of the RPD.

The processing unit 403 may be then configured to extract a plurality of keys of the balanced tree. In an exemplary embodiment of the present disclosure, the plurality of keys may comprise K1, K2, and K3, where K1 is MSB portion of the key and K3 is the LSB part of the keys. All the keys K1, K2, and K3 shall be required for adding or deleting a data entry from the balanced tree.

The processing unit 403 may be configured to determine whether all or a subset of keys of the plurality of keys are required for searching the at least one data entry within the balanced tree. The tree search or lookup operation may be performed either with all keys or subset of keys. For example, tree lookup may be performed using all three keys K1, K2 and K3 or only with K1 and K2. The determination of whether all or a subset of keys are required is based on the at least one identified data entry to be searched.

In an exemplary embodiment, if the at least one identified data entry comprises keys K1 and K2, then only a subset of keys are required for performing the search operation. If the at least one identified data entry comprises keys K1, K2, and K3 then all the keys are required for performing the search operation.

In an embodiment of the present disclosure, in response to the determination that the subset of keys of the plurality of keys are required for searching the at least one data entry, the processing unit 403 may be configured to generate a first compare function for each of the at least one data entry using the subset of keys. The first compare function comprises the subset of keys in a hierarchical order. In an exemplary embodiment, the first compare function generated using subset of keys may be indicated a function ((K1) and (K2)).

The processing unit 403 may be then configured to traverse a first path for the at least one data entry based on the first compare function. To traverse the first path for the at least one data entry, the processing unit 403 may be configured to traverse at least a portion of the balanced tree and detecting one or more duplicate data entry with respect to the at least one data entry.

In an embodiment of the present disclosure, in response to the determination that all keys of the plurality of keys are required for searching the at least one data entry, the processing unit 403 may be configured to generate a second compare function for each of the at least one data entry to be searched using all of the keys. In an exemplary embodiment, the second compare function generated using all the keys may be indicated a function ((K1), (K2), and (K3)).

The processing unit 403 may be then configured to traverse a second path for the at least one data entry based on the second compare function. For traversing the second path for the at least one data entry, the processing unit 403 may be configured to traverse at least a portion of the balanced tree and detecting one or more duplicate data entry with respect to the at least one data entry.

In an embodiment of the present disclosure, the processing unit 403 may be configured to perform an action on the at least one data entry based on at least one of the first or the second traversed path and the action comprises at least one of retrieving the at least one data entry, or adding a data entry, deleting the at least one data entry, or modifying the at least one data entry.

In an embodiment of the present disclosure, the first path and the second path are traversed by passing the first compare function and the second compare function to a balanced tree search routine or an Application Programming Interface (API). The other unit 405 of the system 400a may be configured to perform other functions of the RPD.

FIG. 4(b) shows a block diagram of a system 400(b) for performing a smart tree lookup operation in a balanced tree, in accordance with some embodiments of the present disclosure.

In an embodiment of the present disclosure, the system 400(a) comprises memory unit 402, an identification unit 404, an extraction unit 406, a determination unit 408, a search function generation unit 410, a path traversing unit 412 and other units 414 communicatively coupled with each other. The system 400 (b) may be an RPD or any other device. The memory unit 402 may be configured to store the L2TP session of the RPD. The identification unit 404 may be configured to identify at least one data entry to be searched within the balanced tree. The data entry may be stored in the database of the RPD.

The extraction unit 406 may be configured to extract a plurality of keys of the balanced tree. In an exemplary embodiment of the present disclosure, the plurality of keys may comprise K1, K2, and K3, where K1 is MSB portion of the key and K3 is the LSB part of the keys. All the keys K1, K2, and K3 shall be required for adding or deleting a data entry from the balanced tree.

The determination unit 408 may be configured to determine whether all or a subset of keys of the plurality of keys are required for searching the at least one data entry within the balanced tree. The tree search or lookup operation may be performed either with all keys or subset of keys. For example, tree lookup may be performed using all three keys K1, K2 and K3 or only with K1 and K2. The determination of whether all or a subset of keys are required is based on the at least one identified data entry to be searched.

In an exemplary embodiment, if the at least one identified data entry comprises keys K1 and K2, then only a subset of keys are required for performing the search operation. If the at least one identified data entry comprises keys K1, K2, and K3 then all the keys are required for performing the search operation.

In an embodiment of the present disclosure, in response to the determination that the subset of keys of the plurality of keys are required for searching the at least one data entry, the search function generation unit 410 may be configured to generate a first compare function for each of the at least one data entry using the subset of keys. The first compare function comprises the subset of keys in a hierarchical order. In an exemplary embodiment, the first compare function generated using subset of keys may be indicated a function ((K1) and (K2)).

The path traversing unit 412 may be then configured to traverse a first path for the at least one data entry based on the first compare function. To traverse the first path for the at least one data entry, the path traversing unit 412 may be configured to traverse at least a portion of the balanced tree and detecting one or more duplicate data entry with respect to the at least one data entry.

In an embodiment of the present disclosure, in response to the determination that all keys of the plurality of keys are required for searching the at least one data entry, the search function generation unit 410 may be configured to generate a second compare function for each of the at least one data entry to be searched using all of the keys. In an exemplary embodiment, the second compare function generated using all the keys may be indicated a function ((K1), (K2), and (K3)).

The path traversing unit 412 may be then configured to traverse a second path for the at least one data entry based on the second compare function. For traversing the second path for the at least one data entry, and the path traversing unit 412 may be configured to traverse at least a portion of the balanced tree and detecting one or more duplicate data entry with respect to the at least one data entry.

In an embodiment of the present disclosure, the other unit 414 may be configured to perform an action on the at least one data entry based on at least one of the first or the second traversed path and the action comprises at least one of retrieving the at least one data entry, or adding a data entry, deleting the at least one data entry, or modifying the at least one data entry.

In an embodiment, the units 404-414 may be dedicated hardware units capable of executing one or more instructions stored in the memory 401 or memory unit 402 or memory for system 400(a) and 400(b). In another embodiment, the units 402-414 may be software modules stored in the memory 401 or memory unit 402 which may be executed by the at least one processor for performing the operations of the system 400(a) and 400(b).

The at least one processor and the processing unit 403 may include, but are not restricted to, a general-purpose processor, a Field Programmable Gate Array (FPGA), an Application Specific Integrated Circuit (ASIC), a Digital Signal Processor (DSP), microprocessors, microcomputers, micro-controllers, digital signal processors, central processing units, state machines, logic circuitries, and/or any devices that manipulate signals based on operational instructions. The system 400a and 400b may comprise interfaces including a variety of software and hardware interfaces, for example, a web interface, a graphical user interface, an input device-output device (I/O) interface, an access network interface and the like.

The memory 401 and the memory unit 402 may be communicatively coupled to the at least one processor. The memory 401 and the memory unit 402 may comprise various data and one or more instructions. The memory 401 and the memory unit 402 may comprise various software modules/codes such as, but not limited to, Bluetooth and Wi-Fi drivers. The memory 401 and the memory unit 402 may include a Random-Access Memory (RAM) unit and/or a nonvolatile memory unit such as a Read Only Memory (ROM), optical disc drive, magnetic disc drive, flash memory, Electrically Erasable Read Only Memory (EEPROM), a memory space on a server or cloud and so forth.

Thus, the system 400a and 400b eliminates the requirement of organizing the same set of elements in separate trees. The system 400a and 400b also facilitates different types of lookups on same tree instance by simply having different search functions (one for each lookup) with different set of keys, as long as keys are in hierarchical order. The system 400a and 400b further facilitates reduction in search complexity of lookups with lesser number of keys.

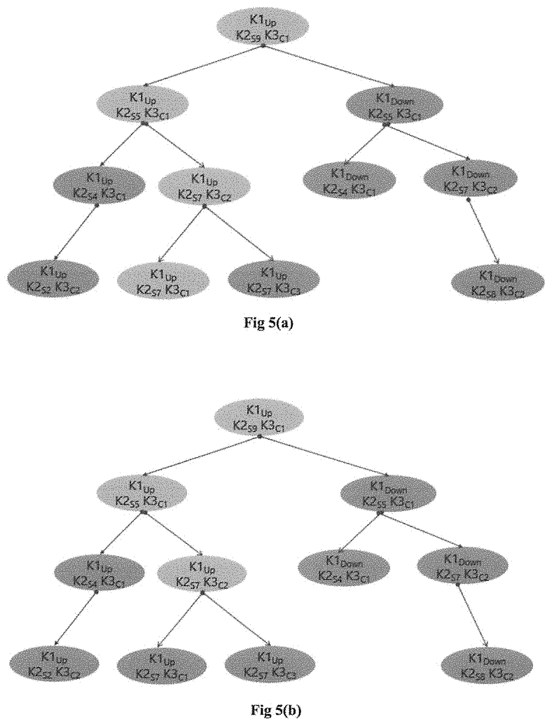

FIG. 5(a) illustrates a smart Balance Tree with 3 keys for performing lookup operations using 3 keys, and FIG. 5(b) illustrates a smart Balance Tree with 3 keys for performing lookup operations using 2 keys, in accordance with some embodiments of the present disclosure.

In an exemplary embodiment of the present disclosure, an RPD may maintain a database of Layer 2 Tunneling Protocol (L2TP) sessions. The L2TP sessions may be in upstream and downstream directions, and are established from one or more CCAP cores. The session tree may then comprise at least the following keys such as direction (upstream or downstream) (K1), session ID (K2), and CCAP core address (K3). However, the number of keys used in above example is not limited to three and a person skilled in the art may use any other key in addition to above-mentioned keys in the session tree.

Considering the following two lookups/traverse use cases:
Case-A—To find whether the tree already has a session entry with given direction, session id and CCAP core address. This type of lookup is typically used for finding a duplicate session add request from the same core.
Case-B—To find whether the tree already has a session entry with given direction and session id (irrespective of CCAP core address). This type of lookup is typically used for finding a duplicate session entries among all the cores.

According to an aspect of the present disclosure, the above-mentioned lookups may be implemented by generating two different compare functions with following keys in hierarchical order within the balanced tree:
Case-A: Direction (upstream or downstream) (K1), Session Id (K2) and CCAP Core Address (K3).
Case-B: Direction (upstream or downstream) (K1) and Session Id (K2).

According to an aspect of the present disclosure, the highlighted blocks in FIG. 5(a) indicate a path traversed for searching the data entry K1ᵤₚ K2_{S7} K3_{C1} using a compare or search function based on all three keys (K1, K2, K3), as discussed in (Case-A). The highlighted blocks in FIG. 5(b) indicate a path traversed for searching the data entry K1ᵤₚ K2_{S7} using a compare or search function based on only two keys (K1, K2), as discussed in (Case-B).

Thus, the technique disclosed in present disclosure facilitates eliminating the requirement of organizing the same set of elements in separate trees and reducing the search complexity with lesser number of keys. Further, the technique of the present disclosure provides different types of lookups on same tree instance by simply having different search functions (one for each lookup) with different set of keys.

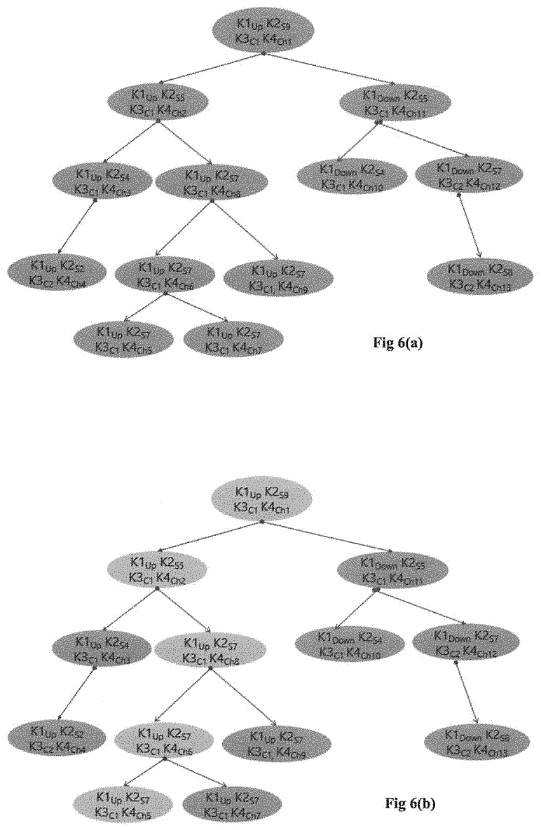

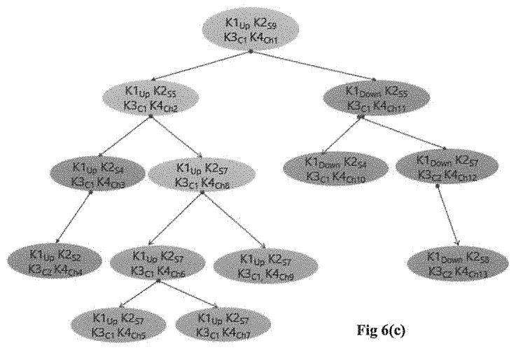

FIG. 6(a) illustrates a smart Balance Tree with 4 keys/levels, in accordance with some embodiments of the present disclosure.

In an embodiment of the present disclosure, the RPD maintains the database of L2TP sessions, where sessions are in upstream and downstream direction and the sessions are established from one or more CCAP cores and for specific downstream/upstream (DS/US) channel(s). In one non-limiting embodiment, sessions could be associated with more than one channel. The session tree may then comprise at least the following keys such as direction (upstream or downstream) (K1), session ID (K2), CCAP core address (K3), DS/US channel ID (K4), as shown in FIG. 6(a). However, the number and/or types of keys used in specific embodiments is not limited to those listed and a person skilled in the art may use any other key in addition to above-mentioned keys in the session tree.

Consider the following two lookups/traverse use cases:
Case-A—To find whether the tree already has a session entry with given direction, session ID, CCAP core address and for a specific DS/US channel. This type of lookup is typically used for finding a duplicate session add request from the same core for a given channel.
Case-B—To list/traverse all the channels associated with a session.

According to an aspect of the present disclosure, lookup/traverse use cases described above (Case-A and Case-B) may be implemented using the two different compare functions with following keys (with hierarchical order as mentioned below) while using the same instance of balanced tree.
Case-A: Direction (upstream or downstream) (K1), Session ID (K2), CCAP Core Address (K3), Channel ID (K4).
Case-B: Direction (upstream or downstream) (K1), Session ID (K2) and CCAP Core Address (K3) and then traverse using all four keys from then on.

FIG. 6(b) illustrates a smart Balance Tree with four keys and that performs lookup operations using all four keys, while FIG. 6(c) illustrates a smart Balance Tree with four keys and that performs lookup operations using only three keys, in accordance with some embodiments of the present disclosure.

According to an aspect of the present disclosure, the highlighted blocks in FIG. 6(b) indicate a path traversed for searching the data entry K1ᵤₚ K2_{S7} K3_{C1} K4_{Ch5} using a compare or search function based on all four keys (K1, K2, K3, K4), as discussed in (Case-A). The highlighted blocks in FIG. 6(c) indicate a path traversed for searching the data entry K1ᵤₚ K2_{S7} K3_{C1} using a compare or search function based on the three keys (K1, K2, K3), as discussed in (Case-B).

In FIG. 6(c), first the data entry K1ᵤₚ K2_{S7} K3_{C1} using three keys and then all the channel entries are traversed. Thus, the technique disclosed in present disclosure facilitates eliminating the requirement of organizing the same set of elements in separate trees and reducing the search complexity with lesser number of keys. Further, the technique of the present disclosure provides different types of lookups on same tree instance by simply having different search functions (one for each lookup) with different set of keys.

In a non-limiting embodiment of the present disclosure, one or more non-transitory computer-readable media may be utilized for implementing the embodiments consistent with the present disclosure. A computer-readable media refers to any type of physical memory (such as the memory 401 and memory unit 402) on which information or data readable by a processor may be stored. Thus, a computer-readable media may store one or more instructions for execution by the at least one processor, including instructions for causing the at least one processor to perform steps or stages consistent with the embodiments described herein. The term “computer-readable media” should be understood to include tangible items and exclude carrier waves and transient signals. By way of example, and not limitation, such computer-readable media can comprise Random Access Memory (RAM), Read-Only Memory (ROM), volatile memory, nonvolatile memory, hard drives, Compact Disc (CD) ROMs, Digital Video Disc (DVDs), flash drives, disks, and any other known physical storage media.

Thus, certain aspects may comprise a computer program product for performing the operations presented herein. For example, such a computer program product may comprise a computer readable media having instructions stored (and/or encoded) thereon, the instructions being executable by one or more processors to perform the operations described herein. For certain aspects, the computer program product may include packaging material.

The terms “an embodiment”, “embodiment”, “embodiments”, “the embodiment”, “the embodiments”, “one or more embodiments”, “some embodiments”, and “one embodiment”, “other embodiment”, “yet another embodiment”, “non-limiting embodiment” mean “one or more (but not all) embodiments of the disclosure(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

A description of an embodiment with several components in communication with each other does not imply that all such components are required. On the contrary, a variety of optional components are described to illustrate the wide variety of possible embodiments of the disclosed methods and systems.

Finally, the language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based here on. Accordingly, the embodiments of the present disclosure are intended to be illustrative, but not limiting, of the scope of the disclosure, which is set forth in the appended claims.

What is claimed is:

1. A method comprising:
identifying at least one data entry to be searched within the balanced tree;
extracting a plurality of keys of the balanced tree;
determining whether all or a subset of keys of the plurality of keys are required for searching the at least one data entry within the balanced tree;
in response to the determination that the subset of keys of the plurality of keys are required for searching the at least one data entry, generating a first compare function for each of the at least one data entry using the subset of keys; and
traversing a first path for the at least one data entry based on the first compare function.

2. The method of claim 1, wherein the first compare function comprises the subset of keys in a hierarchical order.

3. The method of claim 1, wherein traversing the at least one data entry comprises:
traversing at least a portion of the balanced tree; and
detecting one or more duplicate data entry with respect to the at least one data entry.

4. The method of claim 1, further comprising:
in response to the determination that all keys of the plurality of keys are required for searching the at least one data entry:
generating a second compare function for each of the at least one data entry to be searched using all of the keys; and
traversing a second path for the at least one data entry based on the second compare function.

5. The method of claim 4, further comprising:
performing an action on the at least one data entry based on at least one of the first or the second traversed path, wherein the action comprises at least one of: retrieving the at least one data entry, or adding a data entry, deleting the at least one data entry, or modifying the at least one data entry.

6. The method of claim 4, wherein the first path and the second path are traversed by passing the first compare function and the second compare function to a balanced tree search routine or an Application Programming Interface (API).

7. An apparatus comprising:
a memory;
a processing unit in communication with the memory and configured to:
identify at least one data entry to be searched within the balanced tree;
extract a plurality of keys of the balanced tree;
determine whether all or a subset of keys of the plurality of keys are required for searching the at least one data entry within the balanced tree;
in response to the determination that the subset of keys of the plurality of keys are required for searching the at least one data entry, generate a first compare function for each of the at least one data entry using the subset of keys; and
traverse a first path for the at least one data entry based on the first compare function.

8. The apparatus of claim 7, wherein the first compare function comprises the subset of keys in hierarchical order.

9. The apparatus of claim 7, wherein to traverse the at least one data entry the at least one processor is configured to:
traverse at least a portion of the balanced tree; and
detect one or more duplicate data entry with respect to the at least one data entry.

10. The apparatus of claim 7, wherein the processing unit is further configured to:
in response to the determination that all keys of the plurality of keys are required for searching the at least one data entry:
generate a second compare function for each of the at least one data entry to be searched using all of the keys; and
traverse a second path for the at least one data entry based on the second compare function.

11. The apparatus of claim 10, wherein the processing unit is further configured to:
perform an action on the at least one data entry based on at least one of the first or the second traversed path, wherein the action comprises at least one of: retrieving the at least one data entry, or adding a data entry, deleting the at least one data entry, or modifying the at least one data entry.

12. The apparatus of claim 10, wherein the first path and the second path are traversed by passing the first compare function and the second compare function to a balanced tree search routine or an Application Programming Interface (API).

13. A non-transitory computer-readable medium having computer-readable instructions that when executed by a processor causes the processor to perform operations of:
identifying at least one data entry to be searched within the balanced tree;
extracting a plurality of keys of the balanced tree;
determining whether all or a subset of keys of the plurality of keys are required for searching the at least one data entry within the balanced tree;
in response to the determination that the subset of keys of the plurality of keys are required for searching the at least one data entry, generating a first compare function for each of the at least one data entry using the subset of keys; and
traversing a first path for the at least one data entry based on the first compare function.

14. The non-transitory computer-readable medium of claim 13, wherein the first compare function comprises the subset of keys in hierarchical order.

15. The non-transitory computer-readable medium of claim 13, wherein the non-transitory computer-readable medium further comprises computer-readable instructions that when executed by the processor causes the processor to perform operations of:
traversing at least a portion of the balanced tree; and
detecting one or more duplicate data entry with respect to the at least one data entry.

16. The non-transitory computer-readable medium of claim 18, wherein the non-transitory computer-readable medium further comprises computer-readable instructions that when executed by the processor causes the processor to perform operations of:
in response to the determination that all keys of the plurality of keys are required for searching the at least one data entry:
generating a second compare function for each of the at least one data entry to be searched using all of the keys; and
traversing a second path for the at least one data entry based on the second compare function.

17. The non-transitory computer-readable medium of claim 16, wherein the non-transitory computer-readable medium further comprises computer-readable instructions that when executed by the processor causes the processor to perform operations of:
performing an action on the at least one data entry based on at least one of the first or the second traversed path, wherein the action comprises at least one of: retrieving the at least one data entry, or adding a data entry, deleting the at least one data entry, or modifying the at least one data entry.

18. The non-transitory computer-readable medium of claim 16, wherein the first path and the second path are traversed by passing the first compare function and the second compare function to a balanced tree search routine or an Application Programming Interface (API).
